(19) United States
(12) Patent Application Publication
(10) Pub. No.: US 2026/0121107 A1
(43) Pub. Date: Apr. 30, 2026

(54) SOLID ELECTROLYTE LAYER COMPRISING MULTIPLE SUBLAYERS AND ALL SOLID-STATE BATTERY COMPRISING SAME

(71) Applicant: Factorial Inc., Billerica, MA (US)

(72) Inventors: Fang Hao, Andover, MA (US); Daniel Wakaba, Lawrence, MA (US); Hyun Seok Kim, Lexington, MA (US); Minh Nguyen, Lowell, MA (US); Joanna Burdynska, Woburn, MA (US)

(73) Assignee: Factorial Inc., Billerica, MA (US)

(21) Appl. No.: 19/156,477

(22) PCT Filed: May 6, 2025
(86) PCT No.: PCT/US2025/027853

§ 371 Date: Aug. 14, 2025

Related U.S. Application Data
(60) Provisional application No. 63/647,989, filed on May 15, 2024.

(51) Int. Cl. H01M 10/0562; H01M 10/052; H01M 10/0585

(52) U.S. Cl. CPC H01M 10/0562; H01M 10/052; H01M 10/0585; H01M 2300/008; H01M 2300/0094

(57) ABSTRACT

Disclosed is an anode all solid state battery (ASSB) comprising an anode layer, a cathode layer, a solid electrolyte layer therebetween, wherein the solid electrolyte layer comprises a first sublayer adjacent to the anode layer and a second sublayer adjacent to the cathode layer, at least one of the sublayers comprises a scaffold, the scaffold is impregnated with an electrolyte at a side of the at least one of the sublayers, and the side with the scaffold faces toward the other sublayer. The other side with no or less scaffold faces toward the either electrode layer. The ASSB exhibits a decreased impedance and an improved electrochemical performance.

### CROSS-REFERENCE

The present application claims the benefit of U.S. Ser. No. 63/647,989, filed May 15, 2024, the entire content of which is incorporated herein by reference into this application.

### FIELD

Disclosed are a solid electrolyte layer comprising multiple sublayers with at least one sublayer comprising a scaffold, and an electrochemical device comprising the same.

### BACKGROUND

All-solid-state batteries (ASSBs) are being extensively studied due to their better safety and higher energy density in comparison to conventional lithium-ion batteries which are based on organic liquid electrolytes. ASSBs include a solid electrolyte (SE) and the SE layer is usually made of inorganic oxide or sulfide electrolyte and used as substitute for the conventional liquid electrolyte interposed between a cathode layer and an anode layer. The SE layer functions as both electrolyte and separator. In general, a solid electrolyte layer is prepared by coating a slurry on a scaffold disposed on a non-stick base (or substrate) and subsequently peeling from the non-stick base. On one hand, the scaffold has a porous structure and is made of non-ionic conductive material, exhibiting a reduced ionic conductivity. On the other hand, the interfacial resistance between an electrode and the scaffold side of the solid electrolyte layer is higher. Thus, there remains a need for new ASSBs with improved interfacial resistance and methods for preparing the same.

### SUMMARY

The present disclosure provides an all solid-state battery (ASSB) comprising an anode layer, a cathode layer, a solid electrolyte layer between the anode layer and the cathode layer, wherein the solid electrolyte layer comprises a first sublayer adjacent to the anode layer and a second sublayer adjacent to the cathode layer, each sublayer comprises a first side and a second opposing side, the first side of the first sublayer faces the anode layer, the second side of the first sublayer comprises a first scaffold impregnated with a first solid electrolyte, the second side of the first sublayer faces toward the second sublayer, and the second sublayer comprises a second electrolyte and optionally a second scaffold. In some embodiments, the first side of the second sublayer faces the cathode layer, the second side of the second sublayer comprises a second scaffold impregnated with a second solid electrolyte and the second side of the second sublayer faces toward the first sublayer. In some embodiments, the ASSB comprising the solid electrolyte layer exhibits a decreased impedance and an improved electrochemical performance.

The following terms shall be used to describe the present disclosure. In the absence of a specific definition set forth herein, the terms used to describe the present disclosure shall be given their common meaning as understood by those of ordinary skill in the art.

A solid electrolyte layer (alternatively, solid electrolyte membrane or electrolyte film) refers to a thin structure that allows transportation or flow of ions and prevents electronic contact between a cathode and an anode. A solid electrolyte layer has a typical thickness in a range from 5 μm to 300 μm.

The solid electrolyte layer as disclosed herein comprises multiple sublayers, i.e., more than one sublayer. The solid electrolyte layer as disclosed here comprises at least one scaffold in at least one sublayer and is different from scaffold-free electrolyte layer.

The solid electrolyte layer as disclosed herein is an all-solid electrolyte comprising at least one inorganic electrolyte and is different from polymer solid electrolyte, semi-solid electrolyte, and quasi-solid electrolyte, which usually comprises a solvent.

A scaffold (or scaffold layer) refers to a mechanical support layer that is impregnated with an electrolyte via a wet method. An example of a scaffold includes a non-woven substrate with self-supporting property, which may be a porous substrate, such as non-woven fabrics. In some embodiments, “scaffold” is alternatively referred as non-woven fabric, mechanical support layer, mechanical scaffold layer, or support layer.

### BRIEF DESCRIPTION OF THE FIGURES

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIGS. 1A and 1B illustrate two representative configurations of an all-solid state battery (ASSB) with a solid electrolyte layer comprising a scaffold layer.

FIG. 2A illustrates a representative configuration of an ASSB with a solid electrolyte layer comprising two sublayers each comprising a scaffold layer according to some embodiments of the present disclosure.

FIG. 2B illustrates a representative configuration of an ASSB with a solid electrolyte layer comprising two sublayers with one sublayer comprising a scaffold layer according to some embodiments of the present disclosure.

FIG. 3 illustrates a representative configuration of an ASSB with a solid electrolyte layer comprising two or more sublayers according to some embodiments of the present disclosure.

FIG. 4 shows the specific capacities of cells during cycling according to some embodiments of the present disclosure.

FIG. 5 shows the capacity retention rate of cells according to some embodiments of the present disclosure.

FIG. 6 shows the coulombic efficiencies of cells during cycling according to some embodiments of the present disclosure.

### DETAILED DESCRIPTION

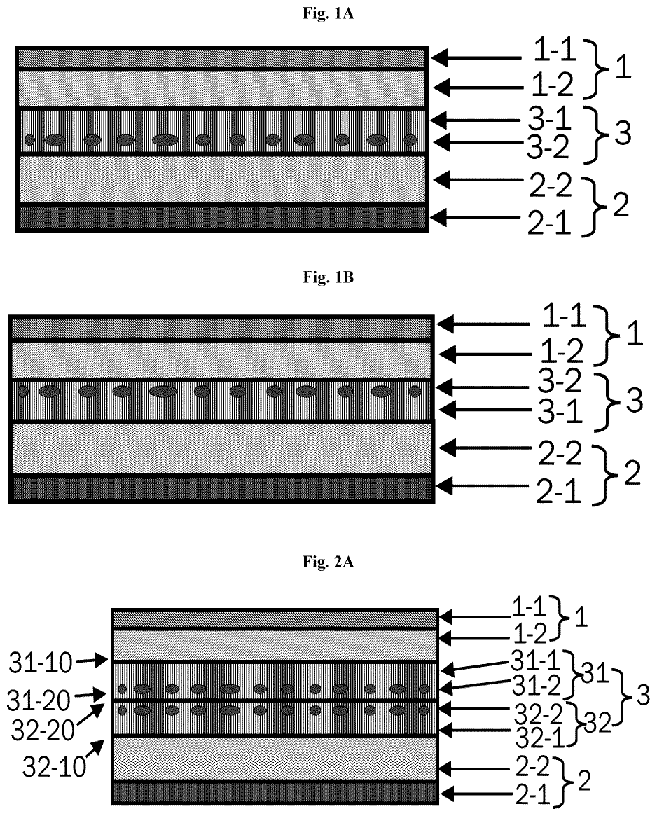

A cross-sectional view of a conventional all-solid state battery (ASSB) is shown in FIGS. 1A and 1B. Such ASSB comprises an anode layer (1), a cathode layer (2), and a solid electrolyte (SE) layer (3) interposed between the anode layer (1) and the cathode layer (2). In some embodiments, the solid electrolyte layer (3) comprises a scaffold (3-2) impregnated with a solid electrolyte (3-1). In some embodiments, the anode layer (1) comprises an anode current collector (1-1) and an anode active material layer (1-2). In some embodiments, the cathode layer (2) comprises a cathode current collector (2-1) and a cathode active material layer (2-2). In some embodiments and as shown in FIG. 1A, the scaffold side of the solid electrolyte layer (3) faces toward the cathode layer (2). Alternatively, the scaffold side faces the anode layer (1) as shown in FIG. 1B. When laminating a solid electrolyte layer (3) with electrodes, the scaffold side of the solid electrolyte layer (3) has to face either electrode, i.e., the cathode layer (2) as shown in FIG. 1A or the anode layer (1) as shown in FIG. 1B, which leads to a high interfacial resistance. The existence of the high interfacial resistance may deteriorate the overall performance of the ASSB.

Disclosed is an ASSB comprising an anode layer, a cathode layer, a solid electrolyte layer therebetween, wherein the solid electrolyte layer comprises a first sublayer adjacent to the anode layer and a second sublayer adjacent to the cathode layer, at least one of the sublayers comprises a scaffold, the scaffold is impregnated with an electrolyte at a side of the at least one of the sublayers, and the side with the scaffold faces toward the other sublayer. The other side with no or less scaffold faces toward the either electrode layer. The ASSB exhibits a decreased impedance and an improved electrochemical performance.

In some embodiments, the ASSB comprises an anode layer, a cathode layer, a solid electrolyte layer between the anode layer and the cathode layer, wherein the solid electrolyte layer comprises a first sublayer and a second sublayer each comprising a first side and a second opposing side. The first sublayer is adjacent to the anode layer and the second sublayer is adjacent to the cathode layer. The first side of the first sublayer faces the anode layer, the second side of the first sublayer comprises a first scaffold impregnated with a first solid electrolyte, the second side of the first sublayer faces toward the second sublayer. The second sublayer comprises a second electrolyte and optionally a second scaffold. In some embodiments, the first side of the second sublayer faces toward the cathode layer, and the second side of the second sublayer comprises a second scaffold impregnated with a second electrolyte and faces toward the first sublayer. In some embodiments, the ASSB comprising the solid electrolyte layer exhibits a decreased impedance and an improved electrochemical performance.

In some embodiments, the all solid state battery (ASSB) comprises an anode layer, a cathode layer, a solid electrolyte between the anode layer and the cathode layer and comprising a first sublayer and a second sublayer layer, the first sublayer comprising a first solid electrolyte with a first scaffold, the second sublayer comprising a second solid electrolyte with a second scaffold, wherein the first scaffold of the first sublayer is adjacent to the second sublayer and the second scaffold of the second sublayer is adjacent to the first sublayer.

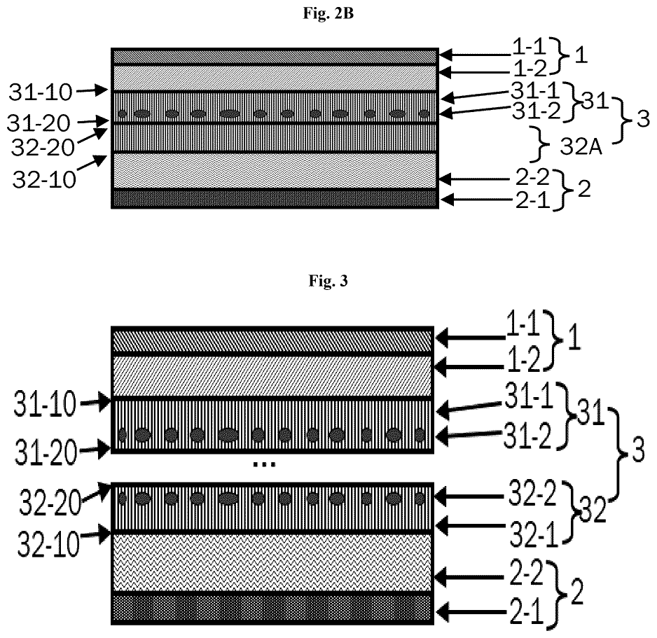

As shown in FIG. 2A, the present disclosure provides an ASSB comprising an anode layer (1), a cathode layer (2) and a solid electrolyte layer (3) therebetween, wherein the solid electrolyte layer (3) comprises a first sublayer (31) and a second sublayer (32) each comprising a first side and a second opposing second side. The first side (31-10) of the first sublayer (31) faces toward the anode layer (1), the first side (32-10) of the second sublayer (32) faces toward the cathode layer (2), the second side (31-20) of the first sublayer (31) comprises a first scaffold (31-2) impregnated with a first solid electrolyte (31-1), the second side (32-20) of the second sublayer (32) comprises a second scaffold (32-2) impregnated with a second solid electrolyte (32-1), the first sublayer's second side (31-20) faces toward the second sublayer (32) and the second sublayer's second side (32-20) faces toward the first sublayer (31).

In some embodiments, the first scaffold (31-2) of the first sublayer (31) faces away from the anode layer (1) and the second scaffold (32-2) of the second sublayer (32) faces away from the cathode layer (2).

In some embodiments and as shown in FIGS. 2A and 3, the first sublayer (31) has a first side (31-10) and a second opposing side (31-20), wherein the first scaffold (31-2) is relatively closer to the second side (31-20) than the first side (31-10). The first side (31-10) is adjacent to or faces the anode layer (1). The first side (31-10) of the first sublayer (31) is adjacent to or faces the anode layer (1). The second side (31-20) of the first sublayer (31) faces away from the anode layer (1).

In some embodiments and as shown in FIGS. 2A and 3, the second sublayer (32) has a first side (32-10) and a second opposing side (32-20), wherein the second scaffold (32-2) of the second sublayer (32) is relatively closer to the second side (32-20) than the first side (32-10). The first side (32-10) of the second sublayer (32) is adjacent to or faces the cathode layer (2). The second side (32-20) of the second sublayer (32) faces away from the cathode layer (2).

Also disclosed is an ASSB comprising an anode layer, a cathode layer, a solid electrolyte layer between the anode layer and the cathode layer, wherein the solid electrolyte layer comprises a first sublayer and a second sublayer each comprising a first side and a second opposing side, the first side of the first sublayer (the side with no or less first scaffold) faces the anode layer, the second side of the first sublayer comprises a first scaffold impregnated with a first solid electrolyte, the second sublayer is scaffold-free and comprises a second solid electrolyte, the second side of the first sublayer faces toward the second sublayer, the first side of the second sublayer faces toward the cathode layer, and the second side of the second sublayer faces toward the first sublayer.

As represented in FIG. 2B, the present disclosure provides an ASSB comprising an anode layer (1), a cathode layer (2) and a solid electrolyte layer (3) therebetween, wherein the solid electrolyte layer (3) comprises a first sublayer (31) and a second sublayer (32A) each comprising a first side and a second opposing second side. The first side (31-10) of the first sublayer (31) faces toward the anode layer (1), the first side (32-10) of the second sublayer (32) faces toward the cathode layer (2), the second side (31-20) of the first sublayer (31) comprises a first scaffold (31-2) impregnated with a first solid electrolyte (31-1). The second sublayer (32A) is free from scaffolds and comprises a second solid electrolyte (32-1), the first sublayer's second side (31-20) faces toward the second sublayer (32A) and the second sublayer's second side (32-20) faces toward the first sublayer (31).

In some embodiments, the ASSB further comprises one or more additional sublayers between the first sublayer (31) and second sublayer (32) as shown in FIG. 3. In some embodiments, the one or more additional sublayers and the second sublayer may or may not include a scaffold.

In some embodiments, the interfacial resistance between the electrolyte layer and the electrodes, typically measured by the impedance of a cell, is at least 5% lower, at least 7.5% lower, at least 10% lower, at least 12.5% lower, at least 15% lower, at least 17.5% or at least 20% lower than that of one comprising a solid electrolyte layer with a scaffold layer without multiple sublayer structure. Without wishing to be bound by any theory, the reduced interfacial resistance may be ascribed to the reduced voids and/or gaps formed along the interface.

In some embodiments, the first solid electrolyte is the same as or different from the second solid electrolyte.

In one embodiment, wherein the first solid electrolyte has a formula LiₓM1_{y}M2_{z}P₁₋ₚM3ₚS_{6-a-b-q}O_{q}ClₐBr_{b} (Formula I), wherein 4≤x≤8, 0≤y<1, 0≤z<1, 0≤p<1, 0≤q<1, 0≤a≤2, 0≤b<2, 0<6-a-b-q<6, 0<1-p≤1, wherein M1 is at least one element of Group 1 or Group 11 other than H or Li of the periodic table, M2 is at least one element of Group 2 of the periodic table, and M3 is at least one element of Group 14 of the periodic table.

In some embodiments, the first solid electrolyte is an oxide-based solid electrolyte or a sulfide-based electrolyte.

In some embodiments, the first and second solid electrolytes independently have a formula LiₓM1_{y}M2_{z}P₁₋ₚM3ₚS_{6-a-b-q}O_{q}ClₐBr_{b}(Formula I), wherein 4≤x≤8, 0≤y<1, 0≤z<1, 0≤p<1, 0≤q<1, 0≤a≤2, 0≤b<2, 0<6-a-b-q<6, 0<1-p≤1, and wherein M1 is at least one element of Group 1 or Group 11 other than H or Li of the periodic table, M2 is at least one element of Group 2 of the periodic table, and M3 is at least one element of Group 14 of the periodic table.

In some embodiments, M1 is at least one selected from the group consisting of Na, K, Rb, Cs, Cu, Ag, and Au. In some embodiments, M2 is at least one selected from the group consisting of Be, Mg, Ca, Sr, and Ba. In some embodiments, M3 is at least one selected from the group consisting of Si, Ge, Sn, and Pb.

In some embodiments, b/a has a value in a range from 0 to 20, i.e, 0≤b/a≤20.

In some embodiments, the formula of sulfide solid electrolyte in the electrolyte layer, i.e., LiₓM1_{y}M2_{z}P₁₋ₚM3ₚS_{6-a-b-q}O_{q}ClₐBr_{b}, does not comprise any of M1, M2, M3 or O, i.e., y=z=p=q=0, corresponding to a formula of LiₓPS_{6-a-b}ClₐBr_{b}.

In some embodiments, the formula of the sulfide electrolyte comprises at least one element selected from the group consisting of M1, M2, M3 and O. In some embodiments, the Formula (I) contains one element selected from the group consisting of M1, M2, M3 and O. In some embodiments, Formula I is selected from the group consisting of:
1) LiₓM1_{y}PS_{6-a-b}ClₐBr_{b}, where 4≤x≤8, 0<y<1, 0≤a≤2, 0≤b<2, 0<6-a-b<6;
2) LiₓM2_{z}PS_{6-a-b}ClₐBr_{b}, where 4≤x≤8, 0<z≤1, 0≤a≤2, 0≤b<2, 0<6-a-b<6;
3) LiₓP₁₋ₚM3ₚS_{6-a-b}ClₐBr_{b}, where 4≤x≤8, 0<p≤1, 0≤a≤2, 0≤b<2, 0<6-a-b<6, 0<1-p<1; and
4) LiₓPS_{6-a-b-q}O_{q}ClₐBr_{b}, where 4≤x≤8, 0<q≤1, 0≤a≤2, 0≤b<2, 0<6-a-b-q<6.

In some embodiments, the Formula (I) contains O and one element selected from the group consisting of M1, M2, and M3. In some embodiments, the sulfide solid electrolyte has a formula selected from the group consisting of LiₓM1_{y}PS_{6-a-b-q}O_{q}ClₐBr_{b}(4≤x≤8, 0<y<10≤q<1, 0≤a≤2, 0≤b<2, 0<6-a-b-q<6), LiₓM2_{y}PS_{6-a-b-q}O_{q}ClₐBr_{b}(4≤x≤8, 0<z<1, 0≤q<1, 0≤a≤2, 0≤b<2, 0<6-a-b-q<6,), and LiₓP₁₋ₚM3ₚS_{6-a-b-q}O_{q}ClₐBr_{b}(4≤x≤8, 0<p<1, 0≤q<1, 0≤a≤2, 0≤b<2, 0<6-a-b-q<6, 0<1-p<1). In one embodiment, the Formula (I) contains O without M1, M2, or M3. In one embodiment, the formula of the sulfide electrolyte is LiₓPS_{6-a-b-q}O_{q}ClₐBr_{b}(4≤x≤8, 0<q<1, 0≤a≤2, 0≤b<2, 0<6-a-b-q<6). In some embodiments, M1 is at least one element of Group 1 or Group 11 other than H or Li of the periodic table. In some embodiments, M1 is at least one selected from the group consisting of Na, K, Rb, Cs, Cu, Ag, and Au. In some embodiments, M2 is at least one element of Group 2 of the periodic table. In some embodiments, M2 is at least one selected from the group consisting of Be, Mg, Ca, Sr, and Ba. In some embodiments, M3 is at least one element of Group 14 of the periodic table. In some embodiments, M3 is at least one selected from the group consisting of Si, Ge, Sn, and Pb.

In one embodiment, the sulfide solid electrolyte has a formula of LiₓPS_{6-a-b-q}O_{q}ClₐBr_{b}, where 4≤x≤8, 0<q≤1, 0≤a≤2, 0≤b<2, 0<6-a-b-q<6. The incorporation of oxygen into the formula makes such material more stable. In some embodiments, the molar amount of O with q having a value in a range from 0 to 0.1, from 0 to 0.2, from 0 to 0.3, from 0 to 0.4, from 0 to 0.5, from 0 to 0.6, from 0.001 to 0.1, from 0.001 to 0.2, from 0.001 to 0.3, from 0.001 to 0.4, from 0.001 to 0.5, from 0.001 to 0.6, from 0.002 to 0.1, from 0.002 to 0.2, from 0.002 to 0.3, from 0.002 to 0.4, from 0.002 to 0.5, from 0.002 to 0.6, from 0.005 to 0.1, from 0.005 to 0.2, from 0.005 to 0.3, from 0.005 to 0.4, from 0.005 to 0.5, from 0.005 to 0.6, or any and all ranges and subranges therebetween. In one embodiment, the formula is Li_{5.8}PS_{4.7}O_{0.1}Cl_{1.2}.

In some embodiments, the formula is LiₓPS_{6-a-b-q}O_{q}ClₐBr_{b}, wherein 4≤x≤8, 0<q≤1, 0≤a≤2, 0<b<2, 0<6-a-b-q<6. In some embodiments, b/a has a value higher than zero. In some embodiments, b/a has a value in a range from 0 to 3.5. In some embodiments, b/a has a value in a range from 0 to 7. In some embodiments, b/a has a value in a range from 0 to 10, from 0 to 15, or from 0 to 20.

In some embodiments, when the formula is LiₓM1_{y}PS_{6-a-b-q}ClₐBr_{b}, 4≤x≤8, 0<y<1, 0≤a≤2, 0≤b<2, 0<6-a-b<6, b/a has a value in a range from 0 to 3.5. In some embodiments, b/a has a value in a range from 0 to 7. In some embodiments, b/a has a value in a range from 0 to 10, from 0 to 15, or from 0 to 20. In some embodiments, b/a has a value higher than zero.

In some embodiments, when the formula is LiₓM2_{z}PS_{6-a-b}ClₐBr, where 4≤x≤8, 0<z≤1, 0≤a≤2, 0≤b<2, 0<6-a-b<6, b/a has a value in a range from 0 to 3.5. In some embodiments, b/a has a value in a range from 0 to 7. In some embodiments, b/a has a value in a range from 0 to 10, from 0 to 15, or from 0 to 20. In some embodiments, b/a has a value higher than zero.

In one embodiment, when the formula is LiₓP₁₋ₚM3ₚS_{6-a-b}ClₐBr_{b}, 4≤x≤8, 0<p≤1, 0≤a≤2, 0≤b<2, 0<6-a-b<6, 0<1-p<1, b/a has a value in a range from 0 to 3.5. In some embodiments, b/a has a value in a range from 0 to 7. In some embodiments, b/a has a value in a range from 0 to 10, from 0 to 15, or from 0 to 20. In some embodiments, b/a has a value higher than zero.

In some embodiments, the Formula (I) contains O and one element selected from the group consisting of M1, M2, and M3. In some embodiments, the sulfide solid electrolyte has a formula selected from the group consisting of LiₓM1_{y}PS_{6-a-b-q}O_{q}ClₐBr_{b} (4≤x≤8, 0<y<1, 0<q<1, 0≤a≤2, 0≤b<2, 0<6-a-b-q<6), LiₓM2_{z}PS_{6-a-b-q}O_{q}ClₐBr_{b} (4≤x≤8, 0<z<1, 0≤q<1, 0≤a≤2, 0≤b<2, 0<6-a-b-q<6,), and LiₓP₁₋ₚM3ₚS_{6-a-b-q}O_{q}ClₐBr_{b} (4≤x≤8, 0<p<1, 0<q<1, 0≤a≤2, 0≤b<2, 0<6-a-b-q<6, 0<1-p<1). In one embodiment, the Formula (I) contains O without M1, M2, or M3. In one embodiment, the formula of the sulfide electrolyte is LiₓPS_{6-a-b-q}O_{q}ClₐBr_{b}(4≤x≤8, 0<q<1, 0≤≤2, 0≤b<2, 0<6-a-b-q<6). In some embodiments, the molar amount of Br in the formula has a value higher than zero, i.e., b>0.

In some embodiments, the total molar amount of the halogen in the formula of sulfide electrolyte is no more than 2, i.e., a+b≤2. In one embodiment, the total molar amount of the halogen in the formula is no less than 2 and no more than 3, i.e., 2≤a+b≤3. In one embodiment, the total molar amount of the halogen in the formula is no less than 2 and less than 4, i.e., 2≤a+b<4. In one embodiment, the total molar amount of Br and Cl in the formula is no more than 2, i.e., a+b≤2, no less than 2 and no more than 3, i.e., 2≤a+b≤3, or no less than 2 and less than 4, i.e., 2≤a+b<4.

In some embodiments, the sulfide solid electrolyte has a formula selected from the group consisting of:
1) LiₓPS_{6-a-b}ClₐBr, where 4≤x≤8, 0≤a≤2, 0≤b<2, 0<6-a-b<6;
2) LiₓM1_{y}PS_{6-a-b}ClₐBr_{b}, where 4≤x≤8, 0<y<1, 0≤a≤2, 0≤b<2, 0<6-a-b<6;
3) LiₓM2_{z}PS_{6-a-b}ClₐBr_{b}, where 4≤x≤8, 0<z<1, 0≤a≤2, 0≤b<2, 0<6-a-b<6;
4) LiₓP₁₋ₚM3ₚS_{6-a-b}ClₐBr_{b}, where 4≤x≤8, 0<p<1, 0≤a≤2, 0≤b<2, 0<6-a-b<6, 0<1-p<1;
5) LiₓPS_{6-a-b-q}O_{q}ClₐBr_{b}, where 4≤x≤8, 0<q≤1, 0≤a≤2, 0≤b<2, 0<6-a-b-q<6;
6) LiₓM1_{y}PS_{6-a-b-q}O_{q}ClₐBr_{b}, where 4≤x≤8, 0<y<1, 0<q<1, 0≤a≤2, 0≤b<2, 0<6-a-b-q<6;
7) LiₓM2_{z}PS_{6-a-b-q}O_{q}ClₐBr_{b}, where 4≤x≤8, 0<z<1, 0≤q<1, 0≤a≤2, 0≤b<2, 0<6-a-b-q<6;
8) LiₓP₁₋ₚM3ₚS_{6-a-b-q}O_{q}ClₐBr_{b}, where 4≤x≤8, 0<p<1, 0<q<1, 0≤a≤2, 0≤b<2, 0<6-a-b-q<6, 0<1-p<1; and mixtures thereof.

In some embodiments, the sulfide solid electrolyte has a formula selected from the group consisting of: Li_{5.8}PS_{4.7}O_{0.1}Cl_{1.2}, Li_{5.9}P_{0.9}Ge_{0.1}S_{4.8}Cl_{1.2}, Li_{5.7}Na_{0.1}PS_{4.8}Cl_{1.2}, Li_{5.4}PS_{4.4}Cl_{0.4}Br_{1.2}, Li_{5.8}PS_{4.8}Cl_{0.4}Br_{0.8}, Li_{5.4}PS_{4.4}Cl_{0.6}Br_{1.0}, Li_{5.4}PS_{4.4}Cl_{0.8}Br_{0.8}, Li_{5.4}PS_{4.4}Cl_{0.8}Br_{0.8}, Li_{5.8}PS_{4.8}Cl_{0.6}Br_{0.6}, Li_{5.4}PS_{4.4}Cl_{1.0}Br_{0.6}, Li_{5.4}PS_{4.4}Cl_{1.2}Br_{0.4}, Li_{5.8}PS_{4.8}Cl_{0.8}Br_{0.4}, Li_{5.8}PS_{4.8}Cl_{1.0}Br_{0.2}, Li_{5.4}PS_{4.4}Cl_{1.4}Br_{0.2} and mixtures thereof.

In some embodiments, the sulfide electrolyte in the solid electrolyte layer as disclosed herein has a cubic crystal structure. In some embodiments, the sulfide electrolyte has a crystal structure in the F4̅3m space group as verified by XRD. In some embodiments, the solid electrolyte is a sulfide solid electrolyte having an argyrodite crystal structure. In some embodiments, the sulfide solid electrolyte has an argyrodite crystal structure with three peaks at 2θ=25.8±0.3, 30.3±0.4 and 31.7±0.4 in X-ray diffractometry using a CuKα ray.

In some embodiments, the solid electrolyte layer with multiple sublayers has an overall thickness in a range from 5 μm to 300 μm, from 10 μm to 300 μm, from 20 μm to 300 μm, from 50 μm to 300 μm, from 5 μm to 200 μm, from 10 μm to 200 μm, from 20 μm to 200 μm, from 50 μm to 200 μm, from 5 μm to 100 μm, from 10 μm to 100 μm, from 20 μm to 100 μm, from 50 μm to 100 μm, from 5 μm to 50 μm, from 10 μm to 50 μm, from 20 μm to 50 μm, or any and all ranges and subranges therebetween.

In some embodiments, each sublayer of the solid electrolyte layer has a thickness in a range from 2 μm to 100 μm, from 5 μm to 100 μm, from 10 μm to 100 μm, from 20 μm to 100 μm, from 2 μm to 50 μm, from 5 μm to 50 μm, from 10 μm to 50 μm, from 20 μm to 50 μm, from 2 μm to 30 μm, from 5 μm to 30 μm, from 10 μm to 30 μm, from 20 μm to 30 μm, or any and all ranges and subranges therebetween.

In some embodiments, the solid electrolyte layer has a lithium-ion conductivity of no less than 0.1 mS/cm, no less than 0.2 mS/cm, no less than 0.5 mS/cm or no less than 1 mS/cm. In some embodiments, the solid electrolyte layer has a lithium-ion conductivity in a range from 0.1 mS/cm to 10 mS/cm, from 0.2 mS/cm to 10 mS/cm, from 0.5 mS/cm to 10 mS/cm, from 1 mS/cm to 10 mS/cm, from 2 mS/cm to 10 mS/cm, from 0.1 mS/cm to 7.5 mS/cm, from 0.2 mS/cm to 7.5 mS/cm, from 0.5 mS/cm to 7.5 mS/cm, from 1 mS/cm to 7.5 mS/cm, from 2 mS/cm to 7.5 mS/cm, from 0.1 mS/cm to 5 mS/cm, from 0.2 mS/cm to 5 mS/cm, from 0.5 mS/cm to 5 mS/cm, from 1.0 mS/cm to 5.0 mS/cm, or any and all ranges and subranges therebetween.

In some embodiments, the binder is a nonfibrillizable binder. In some embodiments, the binder has a weight percentage in a range from 1.0 wt % to 10.0 wt % in the solid electrolyte layer. In some embodiments, the binder is a solution-type or emulsion-type binder. In some embodiments, the binder comprises a polymer selected from the group consisting of polyacrylate, styrene-butadiene rubber (SBR), poly(vinylidene fluoride) (PVDF), vinylidene fluoride/hexafluoropropylene copolymer, polyvinylidene fluoride-co-trichloroethylene, polyacrylonitrile, polymethylmethacrylate, polyvinylpyrrolidone, polyvinylacetate, polyethylene-co-vinyl acetate, polyethylene oxide, arylate copolymer, cellulose acetate, cellulose acetate butyrate, cellulose acetate propionate, polysaccharide polymer and carboxyl methyl cellulose, or a combination thereof. In some embodiments, the binder is homogeneously dispersed in the solid electrolyte layer.

In some embodiments, the ASSB exhibits a capacity retention rate of at least 90%, at least 91%, at least 92%, at least 93%, at least 94%, at least 95%, at least 96%, at least 97%, at least 98%, or at least 99% after at least 50 cycles at a rate of C/3 at 45° C. In some embodiments, the cycling test can be performed at other C rates such as C/6, C/4, C/2, C, 1 C, 2 C, 3 C, 5 C, or any intermediate rate therebetween. In some embodiments, the cycling test can be performed at other temperatures such as −20° C., −10° C., 0° C., 10° C., 20° C. 25° C., 30° C., 40° C., 50° C., 80° C., or any intermediate temperature therebetween. Cycle life is determined by the number of cycles for the battery cell to reach a threshold value such as 80% of its original capacity and is usually used to measure the cycling performance of a secondary battery. In some embodiments, the ASSB comprising the anode assembly exhibits a cycle life which is at least 10%, at least 15%, at least 20%, at least 25%, at least 30%, at least 40%, at least 50%, or at least 60% longer than that of the ones prepared without direct coating.

In one embodiment, the cathode active material layer in the cathode layer of an ASSB comprises a cathode electroactive material. In one embodiment, the cathode active material contains Li, Ni, and Co. In one embodiment, the cathode active material contains Li, Ni, and Co and at least one of Mn and Al. In one embodiment, the cathode active material contains at least one of Fe, and P.

In one embodiment, the cathode active material experiences a redox reaction at a potential of 2 V or above over Li/Li+ during operation of the all solid-state battery.

In some embodiments, the anode active material layer comprises an anode active material such as lithium metal or a lithium alloy. In some embodiments, the anode active material comprises at least one selected from the group consisting of lithium, sodium, magnesium, aluminum, silicon, calcium, titanium, manganese, iron, cobalt, nickel, zinc, molybdenum, silver, indium, tin, and tungsten.

In some embodiments, the anode layer comprises an anode current collector. In some embodiments, an anode active material layer is assembled into an ASSB prior to the first charge. In some embodiments, an anode active material layer is formed after the first charge.

In some embodiments, the anode active material layer of the anode layer contains an anode active material. In some embodiments, the anode active material layer also includes a carbon-based conductive material. In some embodiments, the carbon-based conductive material comprises at least one selected from the group consisting of carbon black, acetylene black, Ketjen black, channel black, furnace black, lamp black, thermal black, natural graphite and artificial graphite.

In some embodiments, the anode layer further comprises an anode protective layer. In some embodiments, the anode protective layer is made of a composite. In some embodiments, the composite comprises a carbonaceous material and particles of element M4 alloyable with lithium. In some embodiments, the carbonaceous material is at least one selected from the group consisting of carbon black, acetylene black, Ketjen black, channel black, furnace black, lamp black, thermal black, natural graphite and artificial graphite. In some embodiments, the element M4 is at least one selected from the group consisting of Ag, Zn, Ti, Cd, Mg, Al, Ga, Si, Ge, In, Sn, Pb, Bi, and Sb. In some embodiments, the anode protective layer has a thickness in a range from 0.1 μm to 50 μm. In some embodiments, the carbonaceous material has a volume percentage in a range from 50% to 90%. In some embodiments, the particles of element M4 have a volume percentage in a range from 10% to 50%. In some embodiments, the particles of element M3 are nanoparticles with an average particle size (D50) in a range from 20 nm to 80 nm in the composite or the composite layer. In some embodiments, the composite further comprises particles of a second element M5 that is not alloyable with lithium. In some embodiments, the second element M5 is at least one selected from the group consisting of Cu, Mo, Ir, W, Co, Ni, Ru, Fe, Se, Ta, Nb, V, and Zr.

In one embodiment, the cathode active material layer of an ASSB comprises a cathode active material. In some embodiments, the ASSB has a relatively high cathode loading. In some embodiments, the ASSB has a cathode loading of at least 5.0 mAh/cm², at least 5.5 mAh/cm², at least 6.0 mAh/cm², at least 6.5 mAh/cm², at least 6.8 mAh/cm², at least 7.2 mAh/cm², or at least 7.5 mAh/cm². A high cathode loading is critical to achieve a high energy density. However, a battery with a high cathode loading may be subject to a relatively fast decay, which ultimately leads to a lower capacity retention. In some embodiments, the present disclosure provides an ASSB having both a high cathode loading and a good cycling performance.

In some embodiments, the ASSB exhibits an impedance at open circuit voltage (OCV) of at least 5% lower, at least 6% lower, at least 7% lower, at least 8% lower, at least 9% lower, at least 10% lower, at least 12.5% lower, at least 15% lower, at least 17.5% lower, at least 20% lower, at least 25% lower, at least 30% lower, at least 35% lower, at least 40% lower, or at least 45% lower than that of one comprising a solid electrolyte layer without multiple sublayer structure.

In some embodiments, the ASSB comprising the solid electrolyte layer exhibits an initial specific capacity of at least 160 mAh/g, at least 165 mAh/g, or at least 170 mAh/g at a rate of C/3 at 45° C. In some embodiments, the ASSB is tested at a pressure in a range from 0.5 MPa to 5.0 MPa.

In some embodiments, the ASSB comprising the solid electrolyte layer exhibits an initial CE of at least 99.0%, at least 99.10%, or at least 99.20% at a rate of C/3 at 45° C.

In some embodiments, after 50 cycles at a rate of C/3 at 45° C., the ASSB comprising the solid electrolyte layer exhibits a specific capacity of at least 150 mAh/g, at least 155 mAh/g, or at least 160 mAh/g. In some embodiments, after 50 cycles at a rate of C/3 at 45° C., the ASSB comprising the solid electrolyte layer exhibits a capacity retention of at least 90%, at least 91.0%, at least 92%. In some embodiments, after 50 cycles at a rate of C/3 at 45° C., the ASSB comprising the solid electrolyte layer exhibits a CE of at least 99.0%, at least 99.10% or at least 99.20%.

In some embodiments, the ASSB comprising the solid electrolyte layer exhibits a cycling life of at least 10% higher, at least 15% higher, at least 20% higher, at least 25% higher, at least 30% higher, at least 35% higher, at least 40% higher, at least 45% higher, or at least 50% higher than that of one comprising an electrolyte layer without multiple sublayer structure.

In one aspect, the present disclosure provides a method of preparing an ASSB. The method may comprise:
1) having a first sublayer comprising a first scaffold impregnated with a first solid electrolyte and a second sublayer comprising a second solid electrolyte and an optional second scaffold, and
2) laminating an anode layer, a solid electrolyte layer comprising the first sublayer and the second sublayer, and a cathode layer in the order, thus obtaining an ASSB comprising the anode layer, the solid electrolyte layer and the cathode layer, wherein each of the first and second sublayers comprises a first side and a second opposing side, wherein the first side of the first sublayer faces the anode layer, the second side of the first sublayer comprises a first scaffold impregnated with a first solid electrolyte and the second side of the first sublayer faces toward the second sublayer.

In some embodiments, the first side of the second sublayer faces the cathode layer, the second side of the second sublayer comprises the second scaffold impregnated with the second solid electrolyte, and the second side of the second sublayer faces toward the first sublayer.

In some embodiments, the first sublayer is the same as or different from the second sublayer. In some embodiments, the first sublayer is prepared by:
1) coating a first slurry to a first scaffold on a first non-stick base, wherein the first slurry comprises a first electrolyte and a first solvent, leading to a coated first slurry on the first non-stick base;
2) drying the coated first slurry on the first non-stick base, leading to a first sublayer comprising the first electrolyte and the first scaffold on the first non-stick base; and
3) peeling the first sublayer from the first non-stick base, thereby obtaining the first sublayer ready for subsequent assembly or lamination.

In some embodiments, the second sublayer is prepared by:
1) coating a second slurry to the second scaffold on a second non-stick base, the second slurry comprising a second electrolyte and a second solvent, leading to a coated second slurry on the second non-stick base;
2) drying the coated second slurry on the second non-stick base, leading to a second sublayer comprising the second electrolyte and the second scaffold on the second non-stick base; and
3) peeling the second sublayer from the second non-stick base, thereby obtaining the second sublayer ready for subsequent assembly or lamination.

In some embodiments, the second sublayer is prepared by applying a second slurry onto the second side of the first sublayer (the side with the first scaffold), thus obtaining a solid electrolyte layer with the first scaffold between the first sublayer and the second sublayer.

In one embodiment, particles of a first electrolyte, a first binder and a first solvent are mixed in a planetary centrifugal mixer to prepare the first slurry. In one embodiment, particles of a second electrolyte, a second binder and a second solvent are mixed in a planetary centrifugal mixer to prepare the second slurry.

In some embodiments, the first and second solvents independently have a weight percentage in a range from 25% to 75%, from 25% to 70%, from 25% to 65%, from 25% to 60%, from 25% to 55%, from 25% to 50%, from 25% to 45%, from 25% to 40%, from 30% to 75%, from 30% to 70%, from 30% to 65%, from 30% to 60%, from 30% to 55%, from 30% to 50%, from 30% to 45%, from 30% to 40%, from 35% to 75%, from 35% to 70%, from 35% to 65%, from 35% to 60%, from 35% to 55%, from 35% to 50%, from 35% to 45%, or all and any ranges and subranges therebetween in the first or second slurry.

In some embodiments, the first solvent is the same as or different from the second solvent. In some embodiments, the first and second solvents are independently selected from the group consisting of comprises xylene, isobutyl isobutyrate and mixtures thereof.

In some embodiments, the first binder is the same as or different from the second binder. In some embodiments, either binder or both can be a solution-type or emulsion-type binder. In some embodiments, the first and second binders are independently selected from the group consisting of a non-aqueous acrylate-type binder, a rubber-type binder such as styrene-butadiene rubber (SBR), poly(vinylidene fluoride) (PVDF), polyethylene (PE), vinylidene fluoride/hexafluoropropylene copolymer, polyvinylidene fluoride-co-trichloroethylene, polyacrylonitrile, polymethylmethacrylate, polyvinylpyrrolidone, polyvinylacetate, polyethylene-co-vinyl acetate, polyethylene oxide, polyarylate, cellulose acetate, cellulose acetate butyrate, cellulose acetate propionate, polysaccharide polymer and carboxyl methyl cellulose. In some embodiments, the first and second binders are nonfibrillizable binders.

In some embodiments, the anode layer, the solid electrolyte layer and the cathode layer are laminated or assembled under a warm isostatic pressing (WIP) process. In some embodiments, the WIP is conducted under a pressure in a range from 100 MPa to 500 MPa. In some embodiments, the WIP is performed at a temperature in a range from 20° C. to 100° C.

The disclosure will be better understood by reference to the Experimental Details which follow, but those skilled in the art will readily appreciate that the specific experiments detailed are only illustrative, and are not meant to limit the disclosure as described herein, as numerous variations and modifications of these exemplary embodiments are possible without undue experimentation. All such variations and modifications are within the scope of the teachings of this disclosure. It will be appreciated that the foregoing description and following examples, no matter how detailed they may appear in text, the disclosure may be practiced in many ways, and the disclosure should be construed in accordance with the appended claims and equivalents thereof.

### Example 1

### Synthesis of Solid Electrolyte Materials

In a glove box having an inert Ar atmosphere, raw precursor powders were prepared at a stoichiometric ratio. The precursor examples include, but are not limited to, Li₂S, Na₂S, P₂S₅, LiCl, LiBr, Li₂O, GeS₂, or combinations thereof. These powders were ball milled planetary ball miller for 4 hours. Subsequently, these powders were sintered at 450° C. for 12 hours.

Thereby, solid electrolyte materials with argyrodite-type structure were obtained. After a grinding procedure, solid electrolyte particles have an average particle size in a range from 1 to 10 μm and will be used for slurry preparation.

### Preparation of ASSBs

Particles of the above sulfide electrolyte with a formula of Li_{5.8}PS_{4.8}Cl_{1.2} were mixed with an acrylate binder and isobutyl isobutyrate as solvent, resulting in a first slurry. The first slurry was applied to a scaffold such as non-woven fabric on a non-stick base followed by peeling the dried coating from the non-stick base after removal of the solvent, thus leading to a first sublayer of solid electrolyte for subsequent lamination. After peeling, the first sublayer did not include nor was attached to the first non-stick base. A second sublayer was similarly prepared using the same solid electrolyte, solvent and binder. An ASSB was assembled using two sublayers each having a thickness of ˜10 μm and comprising a first side and a second side, the first sublayer comprising a first scaffold impregnated with a first electrolyte, the second sublayer comprising a second scaffold impregnated with a second electrolyte, each second side is close to each scaffold in the first and second sublayers, the first side of the first sublayer faces the anode layer, and the first side of the second sublayer faces the cathode layer.

A cell comprising a cathode (85 wt % CAM) with a cathode loading of around 6.8 mAh/cm², an anode, and an SE layer as prepared above was assembled and sealed in a pouch followed by an isostatic pressing.

Two (2) comparative ASSBs were similarly prepared except that a single layer solid electrolyte was used. A solid electrolyte layer was prepared by coating the same slurry onto a non-stick base followed by drying and peeling. An ASSB of comparative example 1 was assembled using the solid electrolyte layer with a thickness of around 20 μm with the second side facing the cathode layer. An ASSB of comparative example 2 was assembled using the solid electrolyte layer with a thickness of around 20 μm and with the second side facing the anode layer.

### Assembly of Cells and Testing

Cells comprising a cathode layer, an anode layer and a solid electrolyte layer with two sublayers or a comparative electrolyte layer were assembled and sealed in a pouch followed by an isostatic pressing.

The impedance was measured using Hioki 3560 AC mOhm Hitester at a frequency of 1000 Hz at the open circuit voltage (OCV) at room temperature. The impedance of full cells is shown in Table 1. It shows that the full cell comprising the solid electrolyte layer with multiple sublayers exhibited an impedance which is 5.95% lower than the comparative examples 1 and 2 in which the side close to the scaffold faced either the cathode layer or the anode layer.

TABLE 1
Impedance of full cells at open circuit voltage (OCV)

| | | | | In comparison |
|---|---|---|---|---|
| | Comparative | Comparative | | to comparative |
| | example 1 | example 2 | Example 1 | example |
| Impedance | 1.85 | 1.85 | 1.74 | 5.95% ↓ |
| (ohm) | | | | |

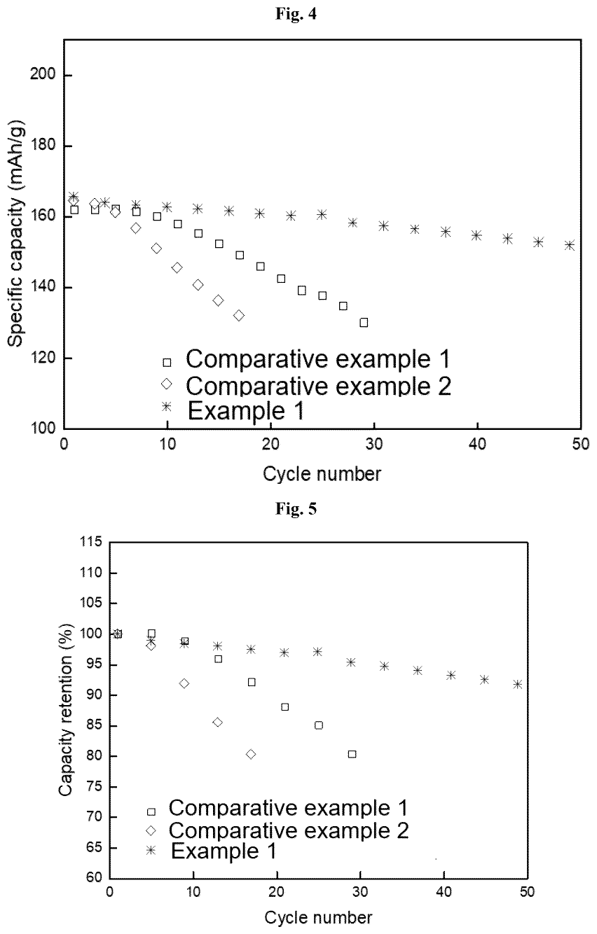

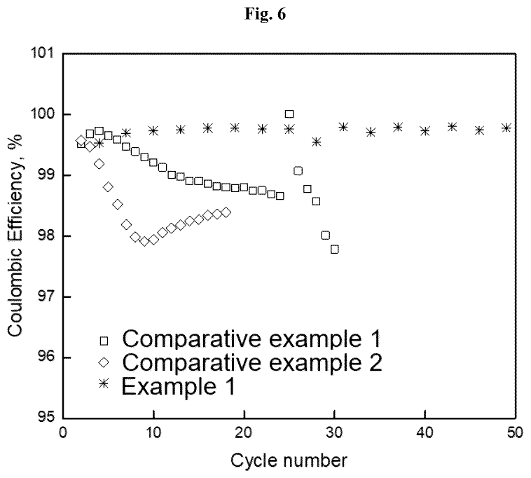

Cycling testing of the cells was conducted at 45° C. with an external pressure in a range from 0.5 MPa to 5.0 MPa, wherein each cycle charges to 4.25 V and discharges to 2.8V at a rate of C/3. Example 1, Comparative Examples 1 and 2 exhibited a similar initial specific capacity around 160 mAh/g. After 50 cycles, as shown in FIGS. 4 and 5, the cell comprising the solid electrolyte layer with multiple sublayers (Example 1) exhibited a specific capacity of higher than 150 mAh/g and a capacity retention rate higher than 90.0%. The cells of comparative examples 1 and 2, however, exhibited a less desirable cycling performance. Both comparative examples exhibited a specific capacity of less than 140 mAh/g after no more than 30 cycles. As shown in FIG. 6, the coulombic efficiency (CE) of Example 1 is consistently higher than 99.0% while the comparative Examples 1 and 2 have a lower CE with less consistency.

### Aspects

In a first aspect of the present disclosure, an all-solid state battery (ASSB) comprises an anode layer, a cathode layer, and a solid electrolyte layer between the anode and cathode layers, wherein the solid electrolyte layer comprises a first sublayer and a second sublayer each comprising a first side and a second opposing side, wherein the first side of the first sublayer faces the anode layer, the second side of the first sublayer comprises a first scaffold impregnated with a first solid electrolyte and the second side of the first sublayer faces toward the second sublayer, wherein the second sublayer comprises a second electrolyte and optional a second scaffold.

In a second aspect according to the first aspect, the first side of the second sublayer faces the cathode layer, the second side of the second sublayer comprises the second scaffold impregnated with the second solid electrolyte, and the second side of the second sublayer faces toward the first sublayer.

In a third aspect according to the first or second aspect, the ASSB exhibits an impedance of at least 5% lower than that of an ASSB comprising a solid electrolyte layer with a scaffold adjacent to the anode layer or cathode layer.

In a fourth aspect according to any preceding aspect, the first and second solid electrolytes are the same or different and wherein the first and second solid electrolytes independently have a formula LiₓM1_{y}M2_{z}P₁₋ₚM3ₚS_{6-a-b-q}O_{q}ClₐBr_{b}(Formula I), wherein 4≤x≤8, 0≤y<1, 0≤z<1, 0≤p<1, 0≤q<1, 0≤a≤2, 0≤b<2, 0<6-a-b-q≤6, 0<1-p≤1, and wherein M1 is at least one element of Group 1 or Group 11 other than H or Li of the periodic table, M2 is at least one element of Group 2 of the periodic table, and M3 is at least one element of Group 14 of the periodic table. In some embodiments, the first and second solid electrolytes are independently selected from the group consisting of
LiₓPS_{6-a-b}ClₐBr_{b}, where 4≤x≤8, 0≤a≤2, 0≤b<2, 0<6-a-b<6;
LiₓM1_{y}PS_{6-a-b}ClₐBr, where 4≤x≤8, 0<y<1, 0≤a≤2, 0≤b<2, 0<6-a-b<6;
LiₓM2_{z}PS_{6-a-b}ClₐBr_{b}, where 4≤x≤8, 0<z<1, 0≤a≤2, 0≤b<2, 0<6-a-b<6;
LiₓP₁₋ₚM3ₚS_{6-a-b}ClₐBr_{b}, where 4≤x≤8, 0<p<1, 0≤a≤2, 0≤b<2, 0<6-a-b<6, 0<1-p<1;
LiₓPS_{6-a-b-q}O_{q}ClₐBr_{b}, where 4≤x≤8, 0<q≤1, 0≤a≤2, 0≤b<2, 0<6-a-b-q<6;
LiₓM1_{y}PS_{6-a-b-q}O_{q}ClₐBr_{b}, where 4≤x≤8, 0<y<1, 0<q<1, 0≤a≤2, 0≤b<2, 0<6-a-b-q<6;
LiₓM2_{z}PS_{6-a-b-q}O_{q}ClₐBr_{b}, where 4≤x≤8, 0<z<1, 0≤q<1, 0≤a≤2, 0≤b<2, 0<6-a-b-q<6;
LiₓP₁₋ₚM3ₚS_{6-a-b-q}O_{q}ClₐBr_{b}, where 4≤x≤8, 0<p<1, 0<q<1, 0≤a≤2, 0≤b<2, 0<6-a-b-q<6, 0<1-p<1 and mixtures thereof.

In a fifth aspect according to any preceding aspect, wherein the first and second scaffolds are the same or different and independently made of a material selected from the group consisting of polyester, polyimide (PI) and polyamide (PA). In some embodiments, the solid electrolyte layer has a thickness in a range from 5 μm to 300 μm.

In a sixth aspect according to any preceding aspect, the cathode layer comprises a cathode current collector and a cathode active material layer on the cathode current collector and the anode layer comprises an anode current collector and an anode active material layer on the anode current collector. In some embodiments, the cathode active material layer comprises at least one cathode active material comprising Li, Ni, and Co and at least one of Mn and Al. In some embodiments, the cathode current collector comprises at least one selected from the group consisting of Al, stainless steel, and alloy thereof. In some embodiments, the anode active material layer comprises at least one anode active material selected from the group consisting of lithium metal and lithium alloy. In some embodiments, the anode current collector comprises at least one selected from the group consisting of Cu, stainless steel, Ti, Ni, Ta, Mo, Nb, Sn, Zn, Ag, Au, and alloy thereof. In some embodiments, the ASSB further comprises one or more sublayers located between the first and second sublayers. One or more of those sublayers may or may not include any scaffold.

In a seventh aspect according to any preceding aspect, the anode layer further comprises an anode protective layer comprising a carbonaceous material and particles of element M4 that is alloyable with lithium. In some embodiments, element M4 is at least one selected from the group consisting of Ag, Zn, Ti, Cd, Mg, Al, Ga, Si, Ge, In, Sn, Pb, Bi, and Sb.

In an eighth aspect according to the seventh aspect, the anode protective layer further comprises particles of second element M5 that is not alloyable with lithium. In some embodiments, the second element M5 is at least one selected from the group consisting of Cu, Mo, Ir, W, Co, Ni, Ru, Fe, Se, Ta, Nb, V, and Zr.

In a nineth eighth aspect according to any preceding aspect, the ASSB has a cathode loading of at least 5.0 mAh/cm².

In a tenth aspect according to any preceding aspect, the ASSB exhibits at least one characteristic selected from the group consisting of:
a. an initial specific capacity of at least 160 mAh/g at a rate of C/3 at 45° C.,
b. an initial CE of at least 99.0% at a rate of C/3 at 45° C.,
c. a specific capacity of at least 150 mAh/g after 50 cycles at a rate of C/3 at 45° C.,
d. a capacity retention of at least 90% after 50 cycles at a rate of C/3 at 45° C., and
e. a CE of at least 99.0% after 50 cycles at a rate of C/3 at 45° C.

In an eleventh aspect, the present disclosure provides a method for preparing an all-solid-state battery (ASSB). The method comprises:
1) having a first sublayer comprising a first scaffold impregnated with a first solid electrolyte, and a second sublayer comprising a second electrolyte and optional a second scaffold, and
2) laminating an anode layer, a solid electrolyte layer comprising the first and second sublayer, and a cathode layer in the order, thereby obtaining an ASSB comprising the anode layer, the solid electrolyte layer and the cathode layer, wherein each of the first and second sublayer has a first side and a second opposing side, the first side of the first sublayer faces the anode layer, the second side of the first sublayer comprises a first scaffold impregnated with a first solid electrolyte and the second side of the first sublayer faces toward the second sublayer.

In a twelfth aspect according to the eleventh aspect, the first side of the second sublayer faces the cathode layer, the second side of the second sublayer comprises the second scaffold impregnated with the second solid electrolyte, and the second side of the second sublayer faces toward the first sublayer.

In a thirteenth aspect according to the eleventh or twelfth aspect, the anode layer, the solid electrolyte layer and the cathode layer are laminated via a warm isostatic pressing (WIP) process. In some embodiments, the WIP process is conducted at a stacking pressure in a range from 100 MPa to 500 MPa. In some embodiments, the WIP process is conducted at a temperature in a range from 20° C. to 100° C.

In a fourteenth aspect according to the eleventh aspect, the first sublayer is prepared by:
a) coating a first slurry to the first scaffold on a first non-stick base, the first slurry comprising a first electrolyte and a first solvent, leading to a coated first slurry on the first non-stick base;
b) drying the coated first slurry on the first non-stick base, leading to a first sublayer comprising the first scaffold impregnated with the first electrolyte on the first non-stick base; and
c) peeling the first sublayer from the first non-stick base, thereby obtaining the first sublayer ready for subsequent lamination; and
   the second sublayer is prepared by:
a) coating a second slurry to the second scaffold on a second non-stick base, the second slurry comprising a second electrolyte and a second solvent, leading to a coated second slurry on the second non-stick base;
b) drying the coated second slurry on the second non-stick base, leading to a second sublayer comprising the second scaffold impregnated with the second electrolyte on the second non-stick base; and
c) peeling the second sublayer from the second non-stick base, thereby obtaining the second sublayer ready for subsequent lamination.

In a fifteenth aspect according to the fourteenth aspect, the first and second solvents are nonaqueous and independently comprise at least one selected from the group consisting of xylene, isobutyl isobutyrate and mixtures thereof. In some embodiments, the first and second solvents independently have a weight percentage ranging from 25% to 75% in the first and second slurries, respectively. In some embodiments, the first and second non-stick bases independently comprise a fluorinated ethylene propylene (FEP) copolymer, perfluoroalkoxy (PFA) polymer, ethylene tetrafluoroethylene (ETFE) copolymer, or a mixture thereof.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternative to the specific embodiments described herein are also within the scope of this disclosure.

1. An all-solid state battery (ASSB) comprising:
a cathode layer;
an anode layer; and
a solid electrolyte layer between the cathode layer and the anode layer and comprising a first sublayer and a second sublayer each comprising a first side and a second opposing side, wherein the first side of the first sublayer faces the anode layer, the second side of the first sublayer comprises a first scaffold impregnated with a first solid electrolyte and the second side of the first sublayer faces toward the second sublayer, wherein the second sublayer comprises a second electrolyte and optional a second scaffold.

2. The ASSB of claim 1, wherein the first side of the second sublayer faces the cathode layer, the second side of the second sublayer comprises the second scaffold impregnated with the second solid electrolyte, and the second side of the second sublayer faces toward the first sublayer.

3. The ASSB of claim 1, wherein the ASSB exhibits an impedance of at least 5% lower than that of an ASSB comprising a solid electrolyte layer with a scaffold adjacent to the anode layer or cathode layer.

4. The ASSB of claim 1, wherein the first and second solid electrolytes are the same or different and wherein the first and second solid electrolytes independently have a formula LiₓM1_{y}M2_{z}P₁₋ₚM3ₚS_{6-a-b-q}O_{q}ClₐBr_{b}(Formula I), wherein 4≤x≤8, 0≤y<1, 0≤z<1, 0≤p<1, 0≤q<1, 0≤a≤2, 0≤b<2, 0<6-a-b-q<6, 0<1-p≤1, and wherein M1 is at least one element of Group 1 or Group 11 other than H or Li of the periodic table, M2 is at least one element of Group 2 of the periodic table, and M3 is at least one element of Group 14 of the periodic table.

5. The ASSB of claim 2, wherein the first and second scaffolds are the same or different and independently made of a material selected from the group consisting of polyester, polyolefin, polyimide (PI) and polyamide (PA).

6. The ASSB of claim 1, wherein the cathode layer comprises a cathode current collector and a cathode active material layer on the cathode current collector and the anode layer comprises an anode current collector and an anode active material layer on the anode current collector.

7. The ASSB of claim 1, wherein the anode layer further comprises an anode protective layer comprising a carbonaceous material and particles of element M4 that is alloyable with lithium, wherein element M4 is at least one selected from the group consisting of Ag, Zn, Ti, Cd, Mg, Al, Ga, Si, Ge, In, Sn, Pb, Bi, and Sb.

8. The ASSB of claim 7, wherein the anode protective layer further comprises particles of second element M5 that is not alloyable with lithium, wherein the second element M5 is at least one selected from the group consisting of Cu, Mo, Ir, W, Co, Ni, Ru, Fe, Se, Ta, Nb, V, and Zr.

9. The ASSB of claim 1, wherein the ASSB has a cathode loading of at least 5.0 mAh/cm².

10. The ASSB of claim 1, wherein the ASSB exhibits at least one characteristic selected from the group consisting of:
a) an initial specific capacity of at least 160 mAh/g at a rate of C/3 at 45° C.,
b) an initial CE of at least 99.0% at a rate of C/3 at 45° C.,
c) a specific capacity of at least 150 mAh/g after 50 cycles at a rate of C/3 at 45° C.,
d) a capacity retention of at least 90% after 50 cycles at a rate of C/3 at 45° C., and
e) a CE of at least 99.0% after 50 cycles at a rate of C/3 at 45° C.,

11. A method for preparing an all-solid state battery (ASSB) comprising:
1) having a first sublayer comprising a first scaffold impregnated with a first solid electrolyte, and a second sublayer comprising a second electrolyte and an optional second scaffold, and
2) laminating an anode layer, a solid electrolyte layer comprising the first and second sublayer, and a cathode layer in the order, thereby obtaining an ASSB comprising the anode layer, the solid electrolyte layer and the cathode layer, wherein the first sublayer is adjacent to the anode layer, the second sublayer is adjacent to the cathode layer, each of the first and second sublayer has a first side and a second opposing side, the first side of the first sublayer faces the anode layer, the second side of the first sublayer comprises a first scaffold impregnated with a first solid electrolyte and the second side of the first sublayer faces toward the second sublayer.

12. The method of claim 11, wherein the first side of the second sublayer faces the cathode layer, the second side of the second sublayer comprises the second scaffold impregnated with the second solid electrolyte, and the second side of the second sublayer faces toward the first sublayer.

13. The method of claim 11, wherein the anode layer, the solid electrolyte layer and the cathode layer are laminated via a warm isostatic pressing (WIP) process, wherein the WIP process is conducted at a stacking pressure in a range from 100 MPa to 500 MPa at a temperature in a range from 20° C. to 100° C.

14. The method of claim 11, wherein the first sublayer is prepared by:
1) coating a first slurry to the first scaffold on a first non-stick base, the first slurry comprising a first electrolyte and a first solvent, leading to a coated first slurry on the first non-stick base;
2) drying the coated first slurry on the first non-stick base, leading to a first sublayer comprising the first scaffold impregnated with the first electrolyte on the first non-stick base; and
3) peeling the first sublayer from the first non-stick base, thereby obtaining the first sublayer ready for subsequent lamination; and
the second sublayer is prepared by:
1) coating a second slurry to the second scaffold on a second non-stick base, the second slurry comprising a second electrolyte and a second solvent, leading to a coated second slurry on the second non-stick base;
2) drying the coated second slurry on the second non-stick base, leading to a second sublayer comprising the second scaffold impregnated with the second electrolyte on the second non-stick base; and
3) peeling the second sublayer from the second non-stick base, thereby obtaining the second sublayer ready for subsequent lamination.

15. The method of claim 14, wherein the first and second solvents are nonaqueous and independently comprise at least one selected from the group consisting of xylene, isobutyl isobutyrate and mixtures thereof.
